(19) United States
(12) Patent Application Publication
(10) Pub. No.: US 2015/0271324 A1
(43) Pub. Date: Sep. 24, 2015

(54) MANAGING A PHONE COMMUNICATION RESPONSE

(71) Applicant: International Business Machines Corporation, Armonk, NY (US)

(72) Inventors: Janani Janakiraman, Austin, TX (US); Dany R. Madden, Beaverton, OR (US); Meenakshi Sripal, Saint Louis, MO (US)

(73) Assignee: International Business Machines Corporation, Armonk, NY (US)

(21) Appl. No.: 14/220,479

(22) Filed: Mar. 20, 2014

(51) Int. Cl. H04M 3/42; H04M 1/725; H04W 4/16

(52) U.S. Cl. CPC H04M 3/42374; H04W 4/16; H04M 1/72519

(57) ABSTRACT

A computer implemented method for managing a phone communication response is disclosed. The method can include creating a set of phone communication response preferences. The method can include setting, in response to a triggering event, a phone communication response configured to provide status information including arrival time information and location information. The method can include resolving, in response to receiving a phone communication, a correlation between identifying information of the phone communication and at least a portion of the set of phone communication response preferences. The method can also include providing, in response to resolving the correlation, the phone communication response.

### BACKGROUND

The present disclosure relates to computer systems, and more specifically, to computer systems for managing a phone communication response.

The use of mobile communication devices such as cell phones, smart phones and tablets is rapidly increasing. Automated response systems are one tool by which users can manage correspondence. As the use of mobile communication devices increases, the need for using automated response systems may also increase.

### SUMMARY

Aspects of the present disclosure, in certain embodiments, relate to a computer implemented method for managing a phone communication response. In certain embodiments, the method can include creating a set of phone communication response preferences. The method can also include setting a phone communication response configured to provide status information including arrival time information and location information. The phone communication response can, in certain embodiments, be set in response to a triggering event. The method can include resolving a correlation between identifying information of the phone communication and at least a portion of the set of phone communication response preferences. The correlation can, in certain embodiments, be resolved in response to receiving a phone communication. The method can include providing, in response to resolving the correlation, the phone communication response.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a high-level example of a network architecture, according to embodiments;

FIG. 2 illustrates an example of a network architecture for a system to manage a phone communication response, according to embodiments;

FIG. 3 is a flowchart illustrating a method for managing a phone communication response, according to embodiments; and

FIG. 4 illustrates modules of a system for managing a phone communication response, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to various embodiments of a system and methodology for a phone communication system. More particular aspects relate to providing a phone communication response containing status information. The status information can be customizable. For example, the status information can include arrival time information and location information. The methodology may include creating a set of phone communication response preferences. Creating the phone communication response preferences (e.g., settings) can include registering a set of allowed source profiles to a profile data group, and selecting accessible status information for at least one source profile. The method can also include setting a phone communication response in response to a triggering event. The phone communication response can be configured to provide the status information. In response to receiving a phone communication, the method can include resolving a correlation between identifying information of the phone communication and at least a portion of the set of phone communication response preferences. In response to resolving the correlation, the methodology can include providing the phone communication response.

As the use of mobile communication devices such as cell phones, smart phones and tablets becomes increasingly more common, the number of calls and messages received by a typical user on a daily basis is similarly increasing. However, aspects of the present disclosure relate to the recognition that, in certain situations, a user may be traveling at the time he or she is contacted, and not be available to respond immediately. For example, a user may be driving or aboard an airplane when he or she receives a phone call, and be unable to respond to the phone call. Accordingly, aspects of the present disclosure relate to a system and method for providing a phone communication response to the initiator of the phone communication without direct action by the user. The phone communication response may include location information and arrival time information in the form of a voicemail message, text message, or other form of response. The user may configure a set of preferences including a list of contacts allowed to receive the phone response, and data to provide for at least one contact. The present disclosure may provide benefits associated with communication performance and efficiency.

Aspects of the present disclosure include a method and system for managing a phone communication system. The method and system may work on a number of devices and operating systems. The method and system can include creating a set of phone communication response preferences. For example, creating the set of phone communication responses can include registering a set of allowed source profiles to a profile data index, and selecting accessible status information for at least one registered source profile. The profile data group can include name information and phone number data for at least one registered source profile.

Aspects of the present disclosure include setting, in response to a triggering event, a phone communication response configured to provide status information. In certain embodiments, the triggering event can include a cue from a cache scheduler configured to update arrival time information and location information at configurable time intervals. For instance, the arrival time information and location information could be configured to be updated at thirty minute intervals. In certain embodiments, the triggering event includes a decrease in a communication signal strength level between a mobile communication device and a cellular network below a threshold level. In certain embodiments, the triggering event can include the scanning of a bar code having air travel information. The bar code can be associated with an air travel application communicatively connected with the phone communication system. In certain embodiments, the triggering event and status information can be associated with a number of checked bags by a traveler.

The status information can include arrival time information and location information. The status information including arrival time information and location information can, in certain embodiments, be determined by a global positioning system used to estimate the arrival time at a known destination. The global positioning system can be communicatively connected to the phone communication system. In certain embodiments, the status information can be determined by using archived travel information to estimate the arrival time at an unknown destination. The archived travel information can include past departure times, arrival times, and other travel data for different days of the week.

Aspects of the present disclosure include resolving, in response to receiving a phone communication, a correlation between identifying information of the phone communication and at least a portion of the set of phone response preferences. Resolving the correlation can include identifying a source profile of the phone communication in response to receiving a phone communication. In response to identifying the source profile, resolving the correlation can include comparing the identified source profile to the profile data group. Additionally, resolving the correlation can include determining a match between the identified source profile and a first profile of the profile data group. Further, the method can include providing the phone communication response in response to determining a match between the identified source profile and a first profile of the profile data group. For example, the phone communication response can be provided to the identified source profile. In certain embodiments, the status information provided with the phone communication response can include a voicemail message and a map.

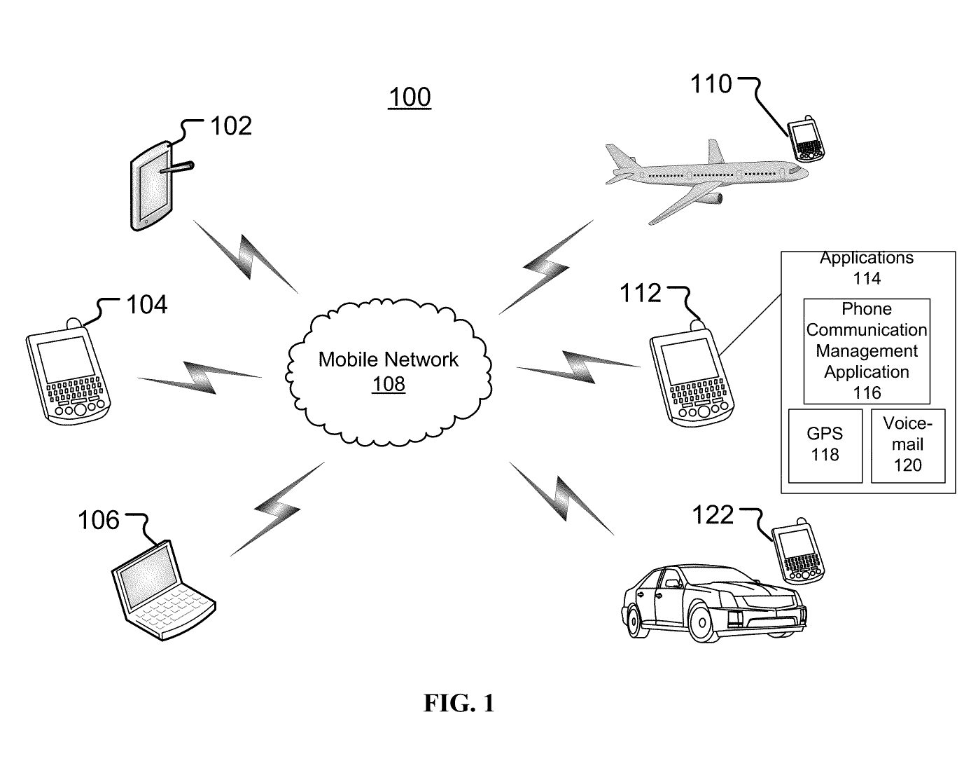

Turning now to the figures, FIG. 1 illustrates a high-level example of a network architecture 100, consistent with embodiments of the present disclosure. Aspects of FIG. 1 are directed toward a network architecture that facilitates the implementation of an application for managing a phone communication response. The network architecture 100 is presented to show one example of an environment where a system and method in accordance with the present disclosure may be implemented. The network architecture 100 is presented only by way of example and is not intended to be limiting. The system and methods disclosed herein may be applicable to a wide variety of different computers, servers, storage devices, and network architectures, in addition to the network architecture 100 shown.

As shown in FIG. 1, the network architecture 100 can include one or more source devices 102, 104, 106 connected to a mobile network 108. The source devices can include home telephones, cellular phones, smartphones, computers, tablets, Personal Digital Assistants (PDAs), and other devices. The mobile network 108 can include, for instance, a cellular network, a local-area-network (LAN), a wide-area network (WAN), the Internet, an intranet, or the like (and various combinations thereof). Consistent with various embodiments, the network architecture 100 can also include one or more receiving devices 110, 112, 122. In certain embodiments, the receiving device 110, 112, 122 may be a mobile device, such as a cellular phone, smartphone, PDA, tablet, or the like. Accordingly, the receiving device 110, 112, 122 may be used by a user engaged in transportation. For example, the user may be driving an automobile, aboard a plane, boat, bus or train, or riding a motorcycle, bicycle, unicycle or other mode of transportation. In certain embodiments, source devices 102, 104, 106 can initiate communication sessions, whereas receiving devices 110, 112, 122 can wait for contact from the source devices 102, 104, 106.

Consistent with various embodiments, the source devices 102, 104, 106 may initiate communication sessions with the receiving devices 110, 112, 122 via the mobile network 108. Aspects of the present disclosure are directed toward a method and system for managing a phone communication response. The method can operate on one or more receiving devices 110, 112, 122, and can provide status information in response to receiving a phone communication from a source device 102, 104, 106. In certain embodiments, the status information can include location information and arrival time information, and can be provided to the source device that initiated the phone communication session. In certain embodiments, the phone communication response can be provided as a voicemail recording, text message or a map.

In certain embodiments, the receiving devices 110, 112, 122 can include one or more applications 114 configured to facilitate providing the phone communication response. For example, the applications can include a phone communication management application 116, a GPS application 118, and a voicemail application 120. The phone communication management application 116 can include a set of phone communication response preferences (e.g., a list of designated contacts allowed to receive the phone communication response and accessible status info for each contact). The GPS application 118 can be communicatively connected to the phone communication management application 116, and can provide estimated arrival time information and location information to be provided with the phone communication response. Further, the voicemail application 120 can be communicatively connected to the phone communication management application 116 and be configured to facilitate creation of a voice message to be provided with the phone communication response.

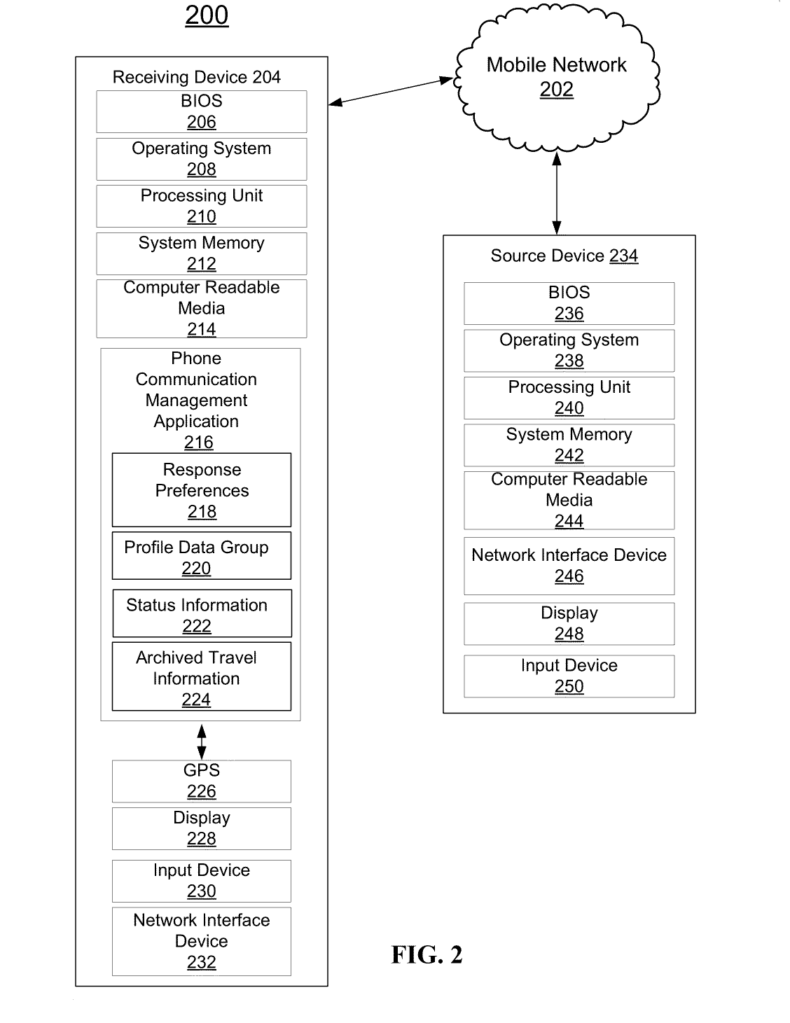

FIG. 2 illustrates an example of a network architecture 200 for a system to manage a phone communication response, consistent with embodiments of the present disclosure. Aspects of FIG. 2 are directed toward a network architecture 200 that facilitates the implementation of a method for managing a phone communication response. Consistent with various embodiments, the network architecture can include a receiving device 204 and a source device 234. In certain embodiments, the receiving device 204 and the source device 234 can be communicatively connected via a mobile network 202. Other communication solutions between the receiving device 204 and the source device 234 are also possible.

Consistent with embodiments of the present disclosure, the network architecture 200 can include a receiving device 204 and a source device 234. Both the receiving device 204 and the source device 234 can include a BIOS (basic input-output system) 206, 236 an operating system 208, 238 one or more processors or processing units 210, 240 a system memory 212, 242 and some form of computer-readable media 214, 244.

As shown in FIG. 2, the receiving device 204 can include one or more forms of computer readable media 214. For example, computer readable media can include storage media, such as random-access memory (RAM), read-only memory (ROM), electrically erasable programmable read-only memory (EEPROM), flash memory, hard disks, optical disk storage, or other mediums that can be used to store information that can be accessed by the receiving device 204. Additionally, computer-readable media can include communication media, such as computer-readable instructions, data structures, and program modules. Wired media, such as a wired network or a direct-wired connection, and wireless media, such as acoustic, radio frequency, infrared and other wireless media are further examples of communication media. Combinations of the above are also included within the scope of computer-readable media.

In certain embodiments, the receiving device 204 and the source device 234 can each include a BIOS 206, 236 and an operating system 208, 238 accessible by the system memory 212, 242. The BIOS 206, 236 and the operating system 208, 238 can facilitate the transfer of information between elements within the receiving device 204 and within the source device 234, respectively. The BIOS 206, 236 can also facilitate the implementation of application programs and other program modules. A user interface can also be linked to the receiving device 204 or the source device 234 that allows a user to interact with the application programs and program modules of the receiving device 204 or the source device 234. For example, the user interface can include a display 228, 248 (e.g., an LCD display screen), and one or more input devices 230, 250 such as a touch screen, a physical keyboard, or other buttons. In certain embodiments, the receiving device 204 can include a network interface device 232, and the source device 234 can include a network interface device 246. The network interface device 232, 246 can be configured to facilitate communication between the receiving device 204, the source device 234, and the mobile network 202.

In certain embodiments, the receiving device 204 can include a phone communication management application 216. As shown in FIG. 2, the phone communication management application 216 can include response preferences 218, a profile data group 220, status information 222, and archived travel information 224. Consistent with various embodiments, the response preferences 218 can allow a user to configure a set of preferences for the phone communication management application 216. For example, the response preferences 218 can, in certain embodiments, allow a user to register a set of allowed source profiles to the profile data group 220. In certain embodiments, the phone communication management application can include status information 222. For example, the status information 222 can include arrival time information and location information for a user traveling from one location to another. For each source profile registered to the profile data group 220, a user can also configure accessible status information 222 that can be provided to the source profile with a phone communication response. In certain embodiments, the phone communication management application 216 can include archived travel information 224. The archived travel information can include a log of past travel data, such as departure times and arrival times at various locations. The phone communication management application can also include a GPS 226. The GPS can be communicatively connected to the phone communication application 216, and can be configured to calculate an estimated arrival time at a particular location for the user.

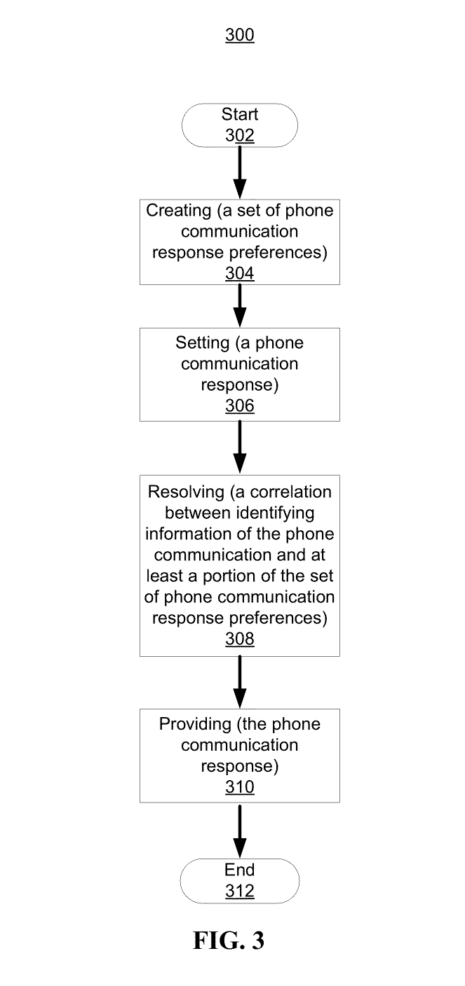

FIG. 3 is a flowchart illustrating a method 300 for managing a phone communication response, consistent with embodiments of the present disclosure. Aspects of FIG. 3 are directed toward providing a phone communication response containing status information to an identified source profile. The method 300 may begin at block 302 and end at block 312. Consistent with various embodiments, the method can include a creating block 304, a setting block 306, a resolving block 308, and a providing block 310.

Consistent with various embodiments, at block 304 the method 300 can include creating a set of phone communication response preferences. The phone communication response preferences can include a plurality of settings for allowing a user to configure the phone communication response. For example, creating the phone communication response preferences can include allowing a user to register a set of source profiles (e.g., contacts) to a profile data group. The profile data group can store information for each registered source profile. For example, the profile data group can store information such as the contact name and phone number of a source profile. For example, a source profile labeled “Dad” having a phone number of 123-867-5309 could be registered to the profile data group. Further, creating the phone communication response preferences can include selecting accessible status information for each source profile registered to the profile data group. In certain embodiments, the status information can include location information and arrival time information. As an example, for the source profile “Dad,” location information and arrival time information could be selected to be provided with a phone communication response in response to receiving a phone communication response from the source profile “Dad.” Other types of status information could also be selected.

Consistent with various embodiments, at block 306 the method 300 can include setting a phone communication response to provide status information. In certain embodiments, setting the phone communication response can occur in response to a triggering event. Consistent with embodiments of the present disclosure, the phone communication response can be implemented in one of a number of different ways. In certain embodiments, the phone communication response can be provided as a voice message. In certain embodiments, the phone communication response can be provided as a text message. In certain embodiments, the phone communication response can be provided as a map, such as a geographical map. Other types of phone communication responses, as well as combinations of various phone communication responses are also possible. For example, in certain embodiments, a voicemail message and a map can be provided as the phone communication response. As described herein, the phone communication response can be configured to include status information, such as arrival time information and location information. As an example, the phone communication response can be provided as a voicemail message including an estimated arrival time at a location. The voicemail message may, in certain embodiments, be an automated digital voice file configured to include the estimated arrival time and location. In certain embodiments, the voice message may include both a user created voice message portion and an automated voice file to provide the status information. A map may also be provided, with one or more locations marked to indicate a current location and a destination. Consistent with various embodiments, the type of phone communication response to be provided can be selected by a user in the phone communication response preferences.

In certain embodiments, the status information can be determined by a global positioning application communicatively connected to the phone communication management system. The global positioning application may, in certain embodiments, be configured to calculate an estimated arrival time at a certain location when a user is en route to a known destination. The estimated arrival time may be provided to the phone communication management system to be provided with the phone communication response. For example, in certain embodiments, a user may indicate an address to which he or she will be traveling, and the global positioning application can calculate an estimated arrival time. The estimated arrival time may be included in the phone communication response.

Aspects of the present disclosure relate to the recognition that, in certain embodiments, the user may be en route to an unknown destination. In such a situation, the global positioning application may be unable to determine status information, such as an estimated arrival time. Accordingly, aspects of the present disclosure relate to consulting a log of archived travel data to compute an estimated arrival time. The log of archived travel data can, for example, contain departure data and arrival data for different locations for different days of the week. As a practical example, a user may depart at 7:30 AM on a Thursday morning toward an unknown destination. In certain embodiments, the archived travel data may indicate that typically, when the user departs at 7:30 AM on Thursday mornings, he or she often arrives at his or her destination between 8:15 AM and 8:25 AM. This information may be included in the phone communication response.

In certain embodiments, the method 300 can include accessing a calendar application in order to determine the status information. For example, the calendar application may have registered events, such as meetings, appointments, social gatherings, and other schedule items that could be used in determining the status information. As an example, in certain embodiments, a user may depart at 4:15 PM on a Wednesday evening toward an unknown destination. In such a situation, the method 300 can include consulting the calendar application. In certain embodiments, the calendar application may list that the user has jazz band practice at 5:00 PM on each Wednesday evening. Based on this information, the method 300 may determine that jazz band practice is the likely intended destination of the user, and may use this to calculate an estimated arrival time. This information may be included in the phone communication response. In certain embodiments, the arrival time information may be related to a number of checked bags (e.g., of a traveler boarding an airplane). For example, more checked bags can indicate a generally later arrival time, particularly when the bags reach a cumulative weight threshold.

As described herein, consistent with various embodiments, setting the phone communication response can occur in response to a triggering event. The triggering event can be one of a number of different types. For example, in certain embodiments, the triggering event can include a cue from a cache scheduler configured to periodically update the arrival time information and location information at configurable time intervals. Put differently, the phone communication response can be automatically updated at set time intervals. Updating the phone communication response can include consulting the global positioning application, calendar application, or archived travel information, and revising the location information or arrival time information. For example, the phone communication response could be configured to be updated every 5 minutes. In certain embodiments, the phone communication response could be configured to be updated every 30 minutes. Other time intervals are also possible.

Consistent with various embodiments, the triggering event can, for example, be a manual command from a user. The user could choose to set the phone communication response to reflect his or her present location or estimated arrival time at a particular destination. In certain embodiments, the triggering event can include a decrease in a communication signal strength level between a mobile communication device and a cellular network. For example, in certain embodiments, the phone communication response could be set in response to the signal strength between the device using the phone communication management application (e.g., receiving device 204 of FIG. 2) and the mobile network (e.g., the mobile network 202 of FIG. 2) dropping below a threshold value. As an example, in certain situations a user may be traveling towards a location where network signal strength is weak. Accordingly, the status information can be updated when the network signal strength decreases below a threshold value (e.g., 20% signal strength), such that up-to-date information could be provided with the phone communication response.

Consistent with various embodiments, the triggering event can include the scanning of a bar code having air travel information. The bar code can be associated with an air travel application communicatively connected with the phone communication system. As an example, in certain situations, a user may make use of an air travel application on a mobile device to display a boarding pass for an airplane flight. The boarding pass may include a bar code that, when scanned, verifies the flight information (e.g., departure time, arrival time, destination) of the user. Accordingly, in certain embodiments, the phone communication response may be set in response to the scanning of a bar code having air travel information. Further, in certain embodiments, the departure time, arrival time, and destination indicated by the bar code can be provided with the phone communication response.

Consistent with various embodiments, at block 308, the method 300 can include resolving a correlation between identifying information (e.g., a source profile) of the phone communication and at least a portion of the set of phone communication response preferences (e.g., a first profile of the profile data group). In certain embodiments, resolving a correlation can include identifying a source profile (e.g., caller) in response to receiving a phone communication. For example, the method 300 can use a phone number associated with the incoming phone communication to identify the source profile. The method 300 may identify a contact name corresponding to the identified source profile from a contact address book. Other methods of identifying the source profile are also possible. In response to identifying the source profile, resolving a correlation can further include comparing the identified source profile to a profile data group. As described herein, the profile data group can include a number of registered source profiles with name information and phone number information, as well as accessible status information for each registered source profile. Additionally, in certain embodiments, resolving a correlation can further include determining a match between the identified source profile and a first profile of the profile data group. Determining the match between the identified source profile and the first profile of the profile data group can be based on phone number information. In certain embodiments, determining the match can be based on contact name information. In response to resolving a correlation between identifying information (e.g., a source profile) of the phone communication and at least a portion of the set of phone communication response preferences, at block 310 the method 300 can include providing the phone communication response. In certain embodiments, the phone communication response can be provided to the identified source profile in the form of a voice message or text message. Other methods of providing the phone communication response are also possible.

Consider the following example. In certain situations, a user may receive a phone communication (e.g., a phone call or text message) while traveling (e.g., driving an automobile) and be unable to safely respond to the phone communication. As described herein, the method 300 can include identifying the source profile (e.g., caller) of the phone communication. As an example, the source profile could have a contact name of “Dad” and a phone number of 123-867-5309. The method 300 can include comparing the phone number to a profile data group having a list of registered source profiles and accessible status information (arrival time information, location information) for each registered source profile. For example, the source profile “Dad” may be registered in the profile data group, and be allowed to access arrival time information and location information. In response to determining a match between the source profile and a first profile of the profile data group (e.g., finding that the phone number 123-867-5309 is registered in the profile data group), the method 300 can include providing to the source profile “Dad” a voicemail message containing the arrival time of the user, and a map displaying the present location of the user.

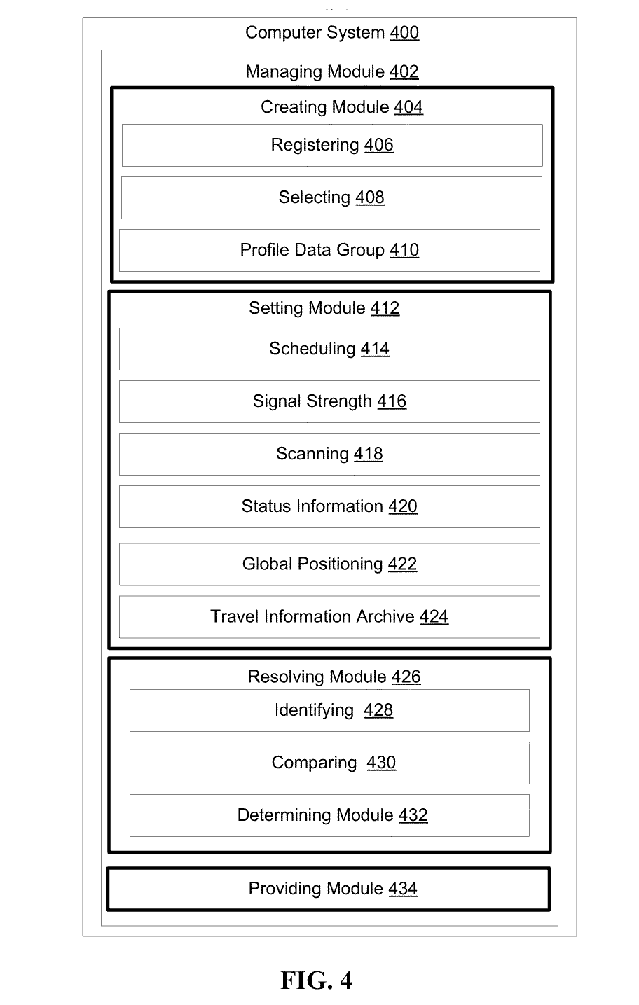

FIG. 4 illustrates modules of a system for managing a phone communication response, consistent with embodiments of the present disclosure. Consistent with various embodiments, method 300 can be implemented using one or more modules of FIG. 4. These modules can be implemented on hardware, software, or firmware executable on hardware, or a combination thereof. For example, these modules may be implemented on an exemplary computer system 400.

The computer system 400 can include a managing module 402. The managing module 402 can be configured to manage a phone communication response. The managing module 402 can include a creating module 404, a registering module 406, a selecting module 408, a profile data group module 410, a setting module 412, a scheduling module 414, a signal strength module 416, a scanning module 418, a status information module 420, a global positional module 422, a travel information archive module 424, a resolving module 426, an identifying module 428, a comparing module 430, a determining module 432, and a providing module 434.

The creating module 404 can include creating a set of phone communication response preferences. Creating the set of phone communication responses can include using a registering module 406 configured to register a set of allowed source profiles to a profile data group, and using a selecting module 408 configured to select accessible status information for each registered source. A profile data group module 410 can be configured to manage name information and phone number data for each registered source profile of the profile data group.

The setting module 412 can be configured to set, in response to a triggering event, a phone communication response configured to provide status information. In certain embodiments, the triggering event can include a cue from a scheduling module 414 configured to update arrival time information and location information at configurable time intervals. For instance, the arrival time information and location information could be configured to be updated at thirty minute intervals. In certain embodiments, the triggering event can include a decrease in a communication signal strength level between a mobile communication device and a cellular network below a threshold level. A signal strength module 416 can be configured to monitor the strength of the communication signal between the mobile communication device and the cellular network. In certain embodiments, the triggering event includes the scanning of a bar code having air travel information. A scanning module 418 can be configured to respond to the scanning of the bar code. The bar code can be associated with an air travel application communicatively connected with the phone communication system.

The status information can include arrival time information and location information. A status information module 420 can be configured to manage the arrival time information, location information and other types of status information. The status information including arrival time information and location information can, in certain embodiments, be determined by a global positioning module 422 configured to estimate the arrival time at a known destination. The global positioning system can be communicatively connected to the phone communication system. In certain embodiments, the status information can be determined by a travel information archive module 424 configured to estimate the arrival time at an unknown destination from a log of past travel data. The log of past travel data can include past departure times, arrival times, and other travel data for different days of the week.

The resolving module 426 can be configured to resolve, in response to receiving a phone communication, a correlation between identifying information of the phone communication and at least a portion of the set of phone communication response preferences. The resolving module 426 can include an identifying module 428 configured to identify, in response to receiving a phone communication, a source profile (e.g., caller) of the phone communication. In response to identifying the source profile, the system can include using a comparing module 430 configured to compare the identified source profile to the profile data group. Further, the system can include using a determining module 432 configured to determine a match between the identified source profile and a first profile of the profile data group. Additionally, the system can include using a providing module 434 configured to provide the phone communication response in response to determining a match between the identified source profile and a first profile of the profile data group. For example, the phone communication response can be provided to the identified source profile. In certain embodiments, the status information provided with the phone communication response can include a voicemail message and a map.

The present invention may be a system, a method, and or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method for managing a phone communication response, the method comprising:
creating a set of phone communication response preferences;
setting, in response to a triggering event, a phone communication response configured to provide status information including arrival time information and location information;
resolving, in response to receiving a phone communication, a correlation between identifying information of the phone communication and at least a portion of the set of phone communication response preferences; and
providing, in response to resolving the correlation, the phone communication response.

2. The method of claim 1, wherein resolving, in response to receiving a phone communication, a correlation between identifying information of the phone communication and at least a portion of the set of phone communication response preferences includes:
identifying, in response to a phone communication, a source profile of the phone communication;
comparing, in response to identifying, the identified source profile to a profile data group; and
determining, in response to comparing, a match between the identified source profile and a first profile of the profile data group.

3. The method of claim 1, wherein creating the set of phone communication response preferences further comprises:
registering, to the profile data group, a set of allowed source profiles; and
selecting, for at least one registered source profile, accessible status information.

4. The method of claim 2, wherein the profile data group includes name information and phone number data for at least one registered source profile.

5. The method of claim 3, wherein the accessible status information provided to the identified source profile includes a voicemail message and a map.

6. The method of claim 1, wherein the status information including arrival time information and location information is determined by at least one of:
a global positioning system used to estimate the arrival time at a known destination, the global positioning system communicatively connected to the phone communication system; or
archived travel information used to estimate the arrival time at an unknown destination, the archived travel information including day information and time information, the archived travel information accessible by the phone communication system.

7. The method of claim 1, wherein the triggering event includes a cue from a cache scheduler configured to periodically update arrival time information and location information at configurable time intervals.

8. The method of claim 1, wherein the triggering event includes a decrease in a communication signal strength level between a mobile communication device and a cellular network below a threshold value.

9. The method of claim 1, wherein the triggering event includes the scanning of a bar code having air travel information, the bar code associated with an air travel application communicatively connected with the phone communication system.

10. A system for managing a phone communication response, the system comprising:
a creating module configured to create a set of phone communication response preferences;
a setting module configured to set, in response to a triggering event, a phone communication response configured to provide status information including arrival time information and location information;
a resolving module configured to resolve, in response to receiving a phone communication, a correlation between identifying information of the phone communication and at least a portion of the set of phone communication response preferences; and
a providing module configured to provide, in response to resolving the correlation, the phone communication response.

11. The system of claim 10, wherein resolving, in response to receiving a phone communication, a correlation between identifying information of the phone communication and at least a portion of the set of phone communication response preferences includes:
an identifying module configured to identify, in response to a phone communication, a source profile of the phone communication;
a comparing module configured to compare, in response to identifying, the identified source profile to a profile data group;
a determining module configured to determine, in response to comparing, a match between the identified source profile and a first profile of the profile data group.

12. The system of claim 10, wherein creating the set of phone communication response preferences further comprises:
a registering module configured to register, to the profile data group, a set of allowed source profiles; and
a selecting module configured to select, for at least one registered source profile, accessible status information.

13. The system of claim 11, wherein the profile data group includes name information and phone number data for at least one registered source profile.

14. The system of claim 12, wherein the accessible status information provided to the identified source profile includes a voicemail message and a map.

15. The system of claim 10, wherein the status information including arrival time information and location information is determined by at least one of:
a global positioning module configured to estimate the arrival time at a known destination, the global positioning system communicatively connected to the phone communication system; or
an archived travel information module configured to estimate the arrival time at an unknown destination, the archived travel information including day information and time information, the archived travel information accessible by the phone communication system.

16. The system of claim 10, wherein the triggering event includes a cue from a cache scheduler configured to periodically update arrival time information and location information at configurable time intervals.

17. The system of claim 10, wherein the triggering event includes a decrease in a communication signal strength level between a mobile communication device and a cellular network below a threshold value.

18. The system of claim 10, wherein the triggering event includes the scanning of a bar code having air travel information, the bar code associated with an air travel application communicatively connected with the phone communication system.

19. A computer implemented method for managing a phone communication response, the method comprising:
registering a set of source profiles to a profile data group, the profile data group including name information and phone number information for at least one profile of the set of source profiles;
selecting, for at least one source profile, accessible status information including location information and arrival time information;
setting, in response to a triggering event, a phone communication response configured to provide the accessible status information including arrival time information and location information;
identifying, in response to receiving a phone communication, a source profile of the phone communication;
comparing, in response to identifying, the identified source profile to a profile data group; and
determining, in response to comparing, a match between the identified source profile and a first profile of the profile data group; and
providing, in response to determining a match, the phone communication response to the identified source profile, the phone communication response including a voicemail message and a geographic map.

20. The method of claim 19, wherein the triggering event includes the scanning of a bar code having air travel information, the bar code associated with an air travel application communicatively connected with the phone communication system, and wherein the air travel information includes a number of checked bags.
